(19) United States
(12) Patent Application Publication
(10) Pub. No.: US 2016/0114773 A1
(43) Pub. Date: Apr. 28, 2016

(54) SLIP CONTROL SYSTEM FOR VEHICLES AND A VEHICLE PROVIDED WITH A SLIP CONTROL SYSTEM

(71) Applicant: AKTIEBOLAGET SKF, Göteborg (SE)

(72) Inventors: Hendrik Anne MOL, Sleeuwijk (NL); Eduardus Gerardus Maria HOLWEG, Göteborg (SE); Stijn Marcus Adriaan Antonius KERST, Den Haag (NL)

(73) Assignee: AKTIEBOLAGET SKF, Göteborg (SE)

(21) Appl. No.: 14/891,428

(22) PCT Filed: Dec. 17, 2013
(86) PCT No.: PCT/EP2013/076926

§ 371 Date: Nov. 16, 2015

(30) Foreign Application Priority Data
May 22, 2013 (EP) PCT/EP2013/060495

(51) Int. Cl. B60T 8/1761

(52) U.S. Cl. CPC B60T 8/1761

(57) ABSTRACT

A slip control system for vehicles having at least one wheel provided with a brake. The slip control system includes at least one sensor and a control device configured to determine a wheel slip of the wheel based on the signals of said sensor. The sensor can be a load sensor provided in a bearing of the wheel.

### CROSS REFERENCE TO RELATED APPLICATIONS

This is a United States National Stage Application claiming the benefit of International Application Number PCT/EP2013/076926 filed on 17 Dec. 2013 (17.12.2013), which claims the benefit of Europe (EP) Patent Application PCT/EP2013/060495 filed on 22 May 2013 (22.05.2013), both of which are incorporated herein by reference in their entireties.

### FIELD OF THE INVENTION

The invention relates to a slip control system for vehicles and to a vehicle comprising a slip control system according to the invention.

### BACKGROUND ART

It is well known to control braking using antilock brake systems and electronic stability systems controlling the braking force of the vehicle in such a way that slip of a tire to a road contact is avoided. Slip control systems according to the prior art use in particular differences and variances in a rolling speed by making use of signals of wheel speed sensors and by calculating differences of the detected wheel speeds.

Further, it is known to provide vehicles with accelerometers and gyroscopes for detecting body movements of the vehicle, which can again be compared with the wing speed in order to detect slippage of the wheels.

Load sensing bearings are known and have been used to measure forces acting upon the bearing and to derive a load of a vehicle from a load of acting on the wheel bearings. A load sensing bearing is disclosed e.g. in the document WO 2009/0769988 A1.

### SUMMARY OF THE INVENTION

It is the object of the invention to provide a slip control system for use in vehicles with improved reliability.

The object is achieved by a slip control system having at least one wheel with a brake. The slip control system comprises a control device and sensors, wherein the control device is configured to determine a wheel slip of the wheel based on the signals of the sensors.

It is proposed that the sensors used by the control device include a load sensor mounted to a bearing that supports the wheel. As will be shown below, the load acting on a bearing is a parameter which can be used to determine a slip of a wheel equipped with a load sensor bearing in a surprisingly reliable way. When using the load sensor provided in the bearing, accelerometers or gyroscopes may be dispensed with.

Bearings that carry loads will deform elastically during their use and this elastic deformation is used to estimate the force acting on the rotating shaft carried by the bearing. Load sensing bearings usually consist of adapted or modified versions of standard bearings which are provided with strain gauges and displacement sensors detecting the elastic deformations in the form of static mode shapes. The deformations can be local i.e. due to rolling element passage and may include overall mode shapes due to a shape and size of the loaded zone and naturally include rigid body modes in translational and rotational form.

During braking, the longitudinal braking force, the normal force due to the vehicle load (weight+driving) and the braking force as a result of friction between a brake claw or caliper and a disc are acting directly or indirectly on the bearing. An indirect effect may consist in that a part of the weight of the vehicle by a direct force transmission path from the wheel over the brake disc and the caliper to the vehicle body such that the bearing is short-circuited. Brake systems of vehicles are usually dimensioned such that a vertical force acting on the bearing is strongly reduced and may even become negative.

Further, it is quite common that the brake caliper is arranged on a side opposite to the direction of normal driving with respect to the axle of the wheel. In most cases, the braking force at the contact between the tire and the road acts in the direction opposite to the normal driving direction and this force is balanced with a reaction force pointing in the normal driving direction with the same absolute value.

The load sensing bearings (LSB) measure the deformation of the bearing using strain gauges and optional displacement sensors positioned around the bearing such that force acting in both the horizontal and vertical plain may be estimated using a multi-variable linear regression analyses applied on the multiple gauges' output by a suitable processor and a control system.

The brake reaction force described above will lead to a deformation of the LSB due to the resulting load which is a function of the braking force. The brake reaction force is of the order of magnitude of the weight on the corner of the vehicle supported by the wheel and the net vertical axis force on this bearing will usually change from positive to negative as described above. This results in a clear measurement of the braking force during braking which is difficult to achieve by other sensors such as accelerometers. The normal force is only a small dynamic component caused by pitching/diving of the vehicle and the brake force is significantly larger than the variation of the normal force on the contact patch of the road-tire surface.

The invention proposes to use the measurement values for both the vertical and horizontal forces acting on the bearing as input for the control device of the slip control system, where it is assumed that the vertical force Fz is a good estimation of the acting brake force Fbrake.

The above description of the invention as well as the appended claims, figures and the following description of preferred embodiments show multiple characterizing features of the invention in specific combinations. The skilled person will easily be able to consider further combinations or sub-combinations of these features in order to adapt the invention as defined in the claims to his or her specific needs.

### BRIEF DESCRIPTION OF THE DRAWINGS

FIG. 1 is a schematic illustration of forces acting on a load sensor bearing during braking of a wheel;

FIG. 2 is a graph illustrating a dependency of a wheel acceleration on slip; and

FIG. 3 is a graph illustrating a relation between a wheel slip and a braking force acting on the bearing.

### DETAILED DESCRIPTION OF THE EMBODIMENTS

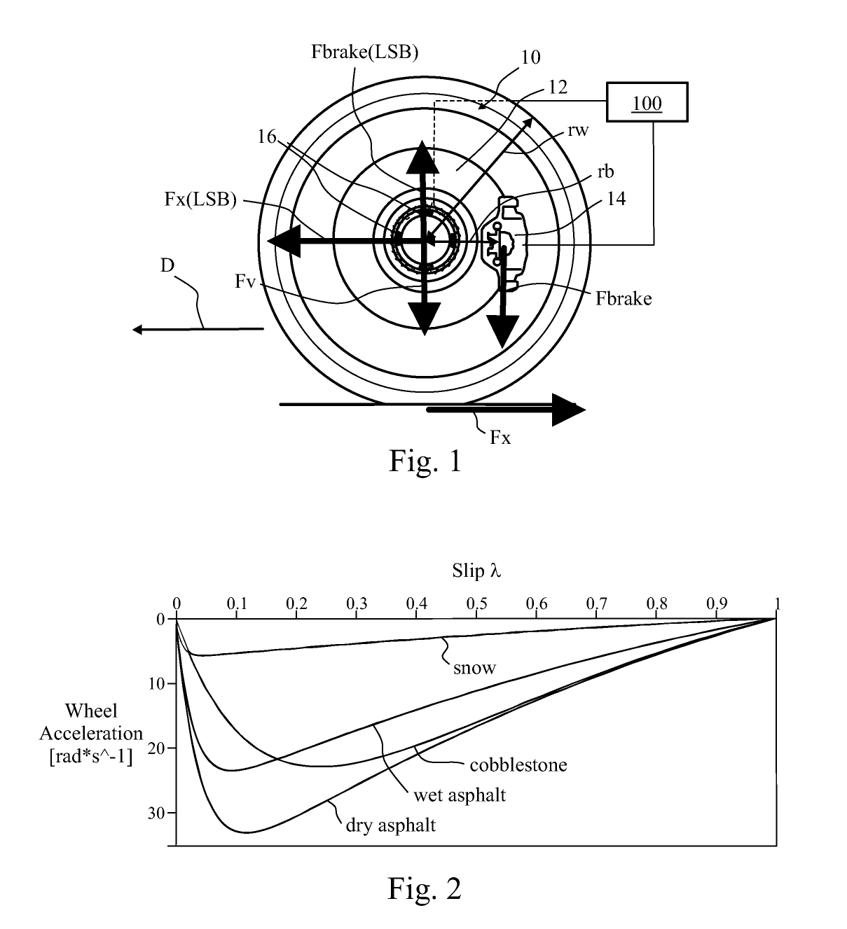

As illustrated in FIG. 1, a wheel 10 of a car is provided with a braking system comprising a brake disc 12 and a caliper 14, wherein the radius of the wheel is indicated with rw and the radius middle point of friction of a brake pad of the caliper 14 is illustrated with rb.

A bearing 11 of FIG. 1 is provided with multiple gauge sensors 16 distributed around the circumference of the wheel 10. For the details of the gauge sensors 16, it is referred to the document WO 2009/076988 A1, which is incorporated herein by reference with regard to the sensor design.

A control unit 100 receives and processes the signals from the sensors 16 in the inner ring of the bearing 11 and is configured to control the braking force applied by a braking pad of the caliper 14 on the brake disc 12 in such a way that a lock-in of the wheel is avoided and driving stability and control is maintained as good as possible even under slippery road conditions.

The forces acting on the wheel, in particular on the bearing 11, are illustrated with bold arrows in FIG. 1.

The vehicle load Fload acts in a vertical direction. When a brake force Fbrake acts in a vertical direction downwards, a braking reaction force Fbrake(LSB) is created acting in the opposite direction upwards. In a similar way, a longitudinal braking force on the tire surface Fx acting between the road and the tire leads to a reaction force Fx(LSB) in the rolling direction D, wherein the absolute value of the reaction force Fx(LSB) corresponds to the longitudinal force Fx. The vehicle load Fload is balanced with a normal force from the road surface (not illustrated). As described above, the quantity Fx*rw/rb is a parameter suitable for determining the variation of the wheel slip over time.

The invention proposes to use the load sensing bearing's Fₓ=Fx(LSB) and F_{z} measurements, i.e. the horizontal and vertical components of the forces as input for ABS control, where we assume that the latter, Fₓ, is a decent estimation of the acting brake force, F_{brake}, and the estimate Fbrake(LSB)=F_{z} is employed.

Using that assumption, the following proves that by the use of brake force control and longitudinal force measurement the wheel slip can be controlled.

The wheel acceleration can be described as:

\dot{ω}·I=Fₓ·r_{w}−F_{brake}·r_{b}

Where:
\dot{ω}[rad/s²]=wheel acceleration
I[kg·m²]=moment of inertia of the wheel
Fₓ[N]=Fx=longitudinal force of the wheel at it's contact path with the road
r_{w}[m]=rw=radius of the wheel
F_{brake}[N]=Fbrake(LSB)=the force applied to the wheel by the brake pad
r_{b}[m]=rb=the distance from wheel center to the brake pad's middle point of friction

Wheel acceleration can be set positive or negative using the following equations:

$$If {F}_{brake} > {F}_{x} \frac{{r}_{w}}{{r}_{b}} ⇒ \dot{ω} < 0$$

$$If {F}_{brake} < {F}_{x} \frac{{r}_{w}}{{r}_{b}} ⇒ \dot{ω} > 0$$

Wheel slip can be described by:

$$λ = \frac{v - ω \cdot {r}_{w}}{v}$$

Where:
λ[−]=the wheel slip (dimensionless)
v[m/s]=the vehicle speed
ω[rad/s]=the wheel speed

And thus:

$$\dot{λ} = - \frac{{r}_{w}}{v} \dot{ω} + \frac{{r}_{w} \cdot ω}{{v}^{2}} \dot{v}$$

Where:
\dot{λ}[1/s]=the change of wheel slip over time
\dot{v}[m/s²]=the vehicle acceleration

Using these equations, combined with the previous equation for wheel acceleration, one can state that:

$$If \dot{ω} > \frac{ω}{v} \dot{v} ⇒ \dot{λ} < 0$$

$$If \dot{ω} < \frac{ω}{v} \dot{v} ⇒ \dot{λ} > 0$$

The output of the expression

$$\frac{ω}{v} \dot{v}$$

is dependent on road surface and slip value, shown in FIG. 1.

FIG. 1 illustrates the value of

$$\frac{ω}{v} \dot{v}$$

for different values of slip, assuming similar slip on all wheels.

It is however sufficient to determine an upper and lower bound, for correct functioning of the system.

$$\frac{ω}{v}$$

can be rewritten to

$$\frac{1 - λ}{{r}_{w}} ,$$

which easily shows that

$$\frac{ω}{v}$$

will be a value between

$$[ 0 … \frac{1}{{r}_{w}} ] .$$

Furthermore, dependent on the type of road surface, \dot{v} will range between [−μₘₐₓ·g . . . 0], where μₘₐₓ[−]=the maximum friction coefficient in the friction curve and g[m/s²]=gravitational acceleration.

This leads to bounds of

$$[ - \frac{g}{{r}_{w}} {μ}_{max} … 0 ] ,$$

which is about [−35 . . . 0] [1/s²] for standard road vehicles.

Combining all together, it can be shown that control of F_{brake} leads to control of \dot{λ}: If \dot{ω}>0→\dot{λ}<0

$$If \dot{ω} < - 35 ⇒ \dot{λ} > 0$$

$$And \text{:}$$

$$If {F}_{brake} < {F}_{x} \frac{{r}_{w}}{{r}_{b}} ⇒ \dot{λ} < 0$$

$$If {F}_{brake} > {F}_{x} \frac{{r}_{w}}{{r}_{b}} + 35 \frac{I}{{r}_{b}} ⇒ \dot{λ} > 0.$$

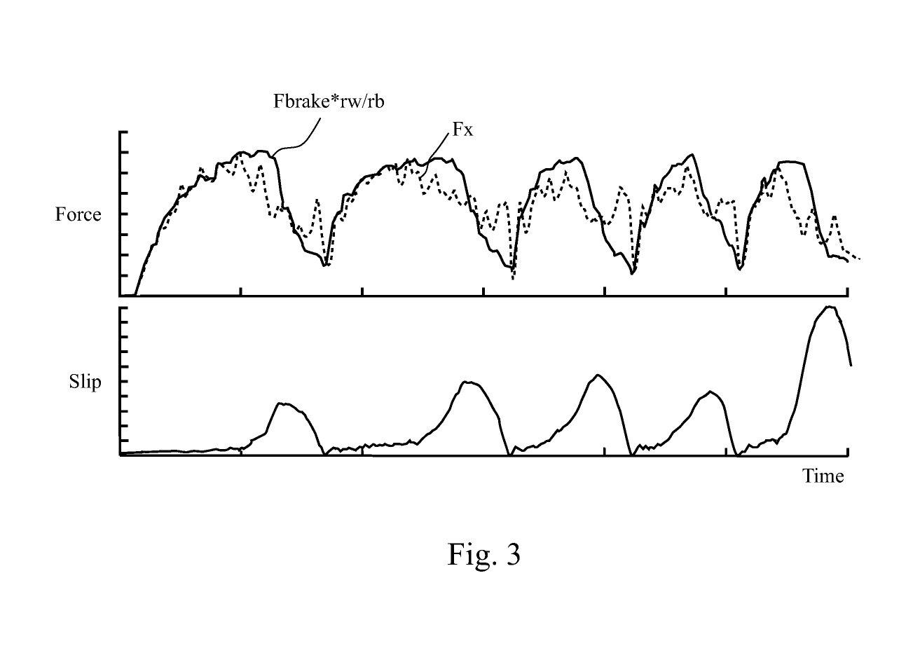

FIG. 3 shows the results of experiments which have been carried out on the front wheels of a standard vehicle which has been modified with load sensing bearings. The picture shows time signals with an x-axis ranging from 5 to 8 seconds. The forces are in the top graph (vertical range 3.0 to 7.0 kN), wherein the solid line trace is the LSB's estimated brake force Fbrake(LSB) scaled with a ratio rb/rw and the dashed trace is the Fx(LSB) component of the force acting on the LSB.

The slip is given as a dimensionless number.

The experiment verifies that the slip decreases when the parameter Fbrake(LSB)*rb/rw is smaller than Fx(LSB) and increases when the parameter Fbrake(LSB)*rb/rw is much larger than Fx(LSB). As a consequence, the experiment shows that the comparison of these quantities is a valuable means for wheel slip of a vehicle.

1. A slip control system for vehicles having at least one wheel provided with a brake, the slip control system comprising:
at least one sensor; and
a control device,
wherein the control device is configured to determine a wheel slip of the wheel based on the signals of the sensor,
wherein the sensor is a load sensor provided in a bearing of the wheel and wherein the load sensor of the bearing is configured to measure a component of load forces acting parallel to the rolling direction of the wheel onto the bearing,
wherein the control device is configured to control and set the braking force based on the longitudinal force acting on the bearing.

2. The slip control system according to claim 1, wherein the brake is provided with a brake caliper arranged on a side of the axle of the wheel opposite to the direction of normal driving.

3. The slip control system according to claim 1
wherein the control device is configured to control and set the braking force based on the longitudinal force acting on the bearing multiplied by a ratio between the radius of the wheel and a radius of the brake pad,
wherein the radius of the brake pad is a distance from the center of the wheel to the middle point of friction of brake pads of the brake.

4. The slip control system according to claim 3, wherein the control device uses the product of the braking force with the ratio of the radius of the wheel and the radius of the middle point of friction of the brake pad to determine a threshold value for the braking force wherein the control device is configured to add a constant to the product to obtain said threshold value.

5. The slip control system according to claim 4, wherein the constant is a product of a numerical constant with a ratio of a moment of inertia of the wheel and the radius of the middle point of friction of the brake pads.

6. The slip control system according to claim 4, wherein the numerical constant amounts to 30 or more.

7. A vehicle provided with a slip control system, the slip control system comprising:
at least one sensor; and
a control device,
wherein the control device is configured to determine a wheel slip of the wheel based on the signals of the sensor,
wherein the sensor is a load sensor provided in a bearing of the wheel,
wherein the slip control system is integrated into the vehicle.

8. A load sensing bearing for use in a slip control system, the slip control system comprising:
at least one sensor; and
a control device,
wherein the control device is configured to determine a wheel slip of the wheel based on the signals of the sensor,
wherein the sensor is a load sensor provided in a bearing of the wheel,
wherein the slip control system is used with the load sensing bearing.

9. The slip control system according to claim 4, wherein the numerical constant amounts to 35 or more.
